(19) United States
(12) Patent Application Publication
(10) Pub. No.: US 2021/0270333 A1
(43) Pub. Date: Sep. 2, 2021

(54) VEHICLE CONTROL SYSTEM

(71) Applicant: Mazda Motor Corporation, Hiroshima (JP)

(72) Inventors: Daisaku OGAWA, Aki-gun (JP); Daisuke UMETSU, Aki-gun (JP); Shinya MORISHITA, Aki-gun (JP)

(73) Assignee: Mazda Motor Corporation, Hiroshima (JP)

(21) Appl. No.: 17/172,093

(22) Filed: Feb. 10, 2021

(30) Foreign Application Priority Data
Mar. 2, 2020 (JP) 2020-035050

(51) Int. Cl. F16D 49/18; B60L 3/10; B60L 15/20

(52) U.S. Cl. CPC F16D 49/18; B60L 3/108; B60L 2240/461; B60L 2250/26; B60L 2240/24; B60L 15/2009

(57) ABSTRACT

In the vehicle control system, a controller may perform first regenerative control that causes a motor generator to perform regeneration so as to apply a braking force to a vehicle when the accelerator is off and, when the accelerator is off and a steering is turned, perform second regenerative control that causes the motor generator to perform regeneration so as to apply a braking force to the vehicle in order to control the vehicle attitude by generating a deceleration that corresponds to a steering angle in the vehicle in addition to the first regenerative control.

### CROSS REFERENCE TO RELATED APPLICATION

The present application claims priority to Japanese patent application JP 2020-035050, filed Mar. 2, 2020, the entire contents of which being incorporated herein by reference in its entirety.

### TECHNICAL FIELD

The present disclosure relates to a vehicle control system that controls the attitude of a vehicle in response to steering.

### BACKGROUND ART

There is a conventionally-known technology for controlling the attitude of a vehicle by reducing the torque given to the vehicle to generate a deceleration in the vehicle so that an operation by the driver during cornering becomes natural and stable when the driver operates the steering wheel (simply referred to below as a “steering”). According to this technology, since the frictional force between the front wheels and the road surface increases and the cornering force of the front wheels increases by quickly applying a load to the front wheels during a steering operation, the turning performance of the vehicle at the initial stage of entering a curve improves and the responsiveness (that is, the maneuverability) with respect to the turning operation of steering improves. As a result, the attitude of the vehicle can be controlled according to the driver's intention. In the following description, the control of the attitude (behavior) of the vehicle in response to such a steering operation is referred to as “vehicle attitude control” as appropriate.

For example, patent document 1 describes the technology for stabilizing a travel during turning by applying a turning assist torque via a motor generator when the vehicle turns. This patent document 1 also describes the deceleration of the vehicle by causing the motor generator to perform regeneration when the accelerator pedal is in the off state (may be referred to below simply as the “accelerator is off”) while the vehicle travels downhill.

### PRIOR ART DOCUMENTS

### Patent Documents

[Patent document 1] JP-A-2014-80128

### SUMMARY

### Problems to be Solved

As described in patent document 1 above, when, for example, the vehicle is traveling downhill and the accelerator pedal is in the off state, the vehicle can be decelerated by performing regeneration via the motor generator to apply a braking force to the vehicle. This can give a feeling of deceleration equivalent to that of, for example, engine braking. In addition, when the steering is turned when the accelerator is off, by performing further regeneration via the motor generator to apply the braking force to the vehicle, the vehicle attitude control described above can be achieved and the turning performance and the maneuverability of the vehicle can be improved. In the following description, the application of a braking force to the vehicle by regeneration via the motor generator is referred to below as “regenerative braking” as appropriate.

However, when regenerative braking via the motor generator is used for both deceleration and vehicle attitude control as described above, the vehicle may slip. In particular, the vehicle is likely to slip when traveling on a low-friction road. When the vehicle slips, an anti-lock brake system (ABS) may operate so as to control the braking force of the brake in order to eliminate or avoid the locked state of the wheels. When this ABS operates, the braking force is applied to the wheels to make the turning of the vehicle difficult, that is, the turning performance of the vehicle degrades. That is, the above improvement of the turning performance by vehicle attitude control cannot be properly exhibited.

The present disclosure addresses the above-described, and other, problems with an object of providing a vehicle control system capable of appropriately performing the regenerative braking via the generator for vehicle deceleration and vehicle attitude control in the range in which the ABS does not operate.

### Means for Solving the Problems

To achieve the above objects, according to some embodiments of the present disclosure, there is provided a vehicle control system, including a generator configured to perform power regeneration by being driven by a wheel of a vehicle; a steering wheel configured to be operated by a driver; a steering angle sensor configured to detect a steering angle corresponding to an operation of the steering wheel; and a controller configured to perform first regenerative control that causes the generator to perform power regeneration so as to apply a braking force to the vehicle when an accelerator pedal of the vehicle is in an off state and perform second regenerative control that causes the generator to perform power regeneration so as to apply another braking force to the vehicle in order to control a vehicle attitude by generating, in the vehicle, a deceleration that corresponds to the steering angle detected by the steering angle sensor in addition to the first regenerative control when the accelerator pedal of the vehicle is in the off state and the steering wheel is turned, in which the controller operates an anti-lock brake system so as to suppress a locked state of the wheel when a predetermined wheel state value indicating the locked state of the wheel is equal to or more than a first threshold, and the controller reduces a first regenerative amount of power applied in the first regenerative control and/or a second regenerative amount of power applied in the second regenerative control if the wheel state value is equal to or more than a second threshold that is less than the first threshold when the accelerator pedal is in the off state and the steering wheel is turned.

According to some embodiments of the present disclosure configured as described above, if the wheel state value is equal to or more than the second threshold that is less than the first threshold above which the ABS operates when the accelerator is off and the steering is turned, the controller reduces the first regenerative amount applied in the first regenerative control to decelerate the vehicle and/or the second regenerative amount applied in the second regenerative control for vehicle attitude control (the first regenerative amount and the second regenerative amount are defined as absolute values. This is also true of the following description).

This can appropriately prevent the wheel state value from exceeding the first threshold of the ABS when the regenerative braking via the generator for vehicle deceleration and vehicle attitude control is performed. Accordingly, according to some embodiments of the present disclosure, the deceleration of the vehicle and vehicle attitude control can be appropriately achieved by the regenerative braking of the generator in the range in which the ABS does not operate.

In some embodiments of the present disclosure, the controller reduces both the first regenerative amount and the second regenerative amount if the wheel state value is equal to or more than the second threshold when the accelerator pedal is in the off state and the steering wheel is turned.

According to some embodiments of the present disclosure configured as described above, the ABS can be prevented from operating more effectively when the regenerative braking via the generator for vehicle deceleration and vehicle attitude control is performed.

In some embodiments of the present disclosure, the controller sets the second regenerative amount less than the first regenerative amount, and reduces the first regenerative amount at a predetermined change rate and reduces the second regenerative amount at a change rate corresponding to the first regenerative amount.

According to some embodiments of the present disclosure configured as described above, the first regenerative amount and the second regenerative amount can be appropriately reduced so as to appropriately ensure both the vehicle deceleration and the vehicle attitude control by regenerative braking.

In some embodiments of the present disclosure, the controller reduces the first regenerative amount and the second regenerative amount until the wheel state value reduces to a third threshold that is less than the second threshold.

According to some embodiments of the present disclosure configured as described above, the controller continues to reduce the regeneration amount until the wheel state value reduces to the third threshold or less that is less than the second threshold after the wheel state value becomes equal to or more than the second threshold. This can appropriately prevent the hunting of the wheel state value.

In some embodiments of the present disclosure, the controller increases the first regenerative amount at a predetermined change rate before the wheel state value is equal to or more than the second threshold and, after the wheel state value reduces to the third threshold as a result of reducing the first regenerative amount because the wheel state value is equal to or more than the second threshold, increases the first regenerative amount again at a change rate less than the change rate used to increase the first regenerative amount before the wheel state value is equal to or more than the second threshold, and the controller increases the second regenerative amount at a predetermined change rate before the wheel state value is equal to or more than the second threshold and, after the wheel state value reduces to the third threshold as a result of reducing the second regenerative amount because the wheel state value is equal to or more than the second threshold, increases the second regenerative amount again at a change rate less than the change rate used to increase the second regenerative amount before the wheel state value is equal to or more than the second threshold.

According to some embodiments of the present disclosure configured as described above, the execution of regenerative braking for vehicle deceleration and vehicle attitude control can be ensured while the ABS is surely prevented from operating.

In a example of the present disclosure, the wheel state value is a difference between a wheel speed (front wheel speed) of a front wheel of the vehicle and a wheel speed (rear wheel speed) of a rear wheel of the vehicle.

### Advantages

According to the vehicle control system according to some embodiments of the present disclosure, the regenerative braking via the generator for vehicle deceleration and vehicle attitude control can be appropriately performed in the range in which the ABS does not operate.

### BRIEF DESCRIPTION OF THE DRAWINGS

FIG. 1 is a block diagram schematically illustrating the overall structure of a vehicle according to an embodiment of the present disclosure.

FIG. 2 is a block diagram illustrating the electric structure of the vehicle according to the embodiment of the present disclosure.

FIG. 3 is a flowchart illustrating overall control processing according to the embodiment of the present disclosure.

FIG. 4 is a flowchart illustrating regenerative control processing according to the embodiment of the present disclosure.

FIG. 5 is a map illustrating the relationship between the additional deceleration and the steering speed according to the embodiment of the present disclosure.

FIG. 6 is a time chart when the control according to the embodiment of the present disclosure is performed.

### MODES FOR CARRYING OUT THE DISCLOSURE

A vehicle control system according to an embodiment of the present disclosure will be described with reference to the attached drawings.

### <Structure of Vehicle>

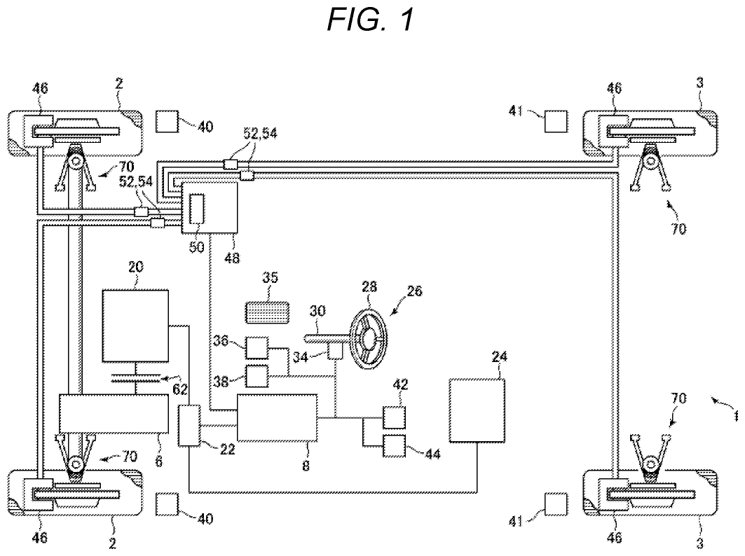

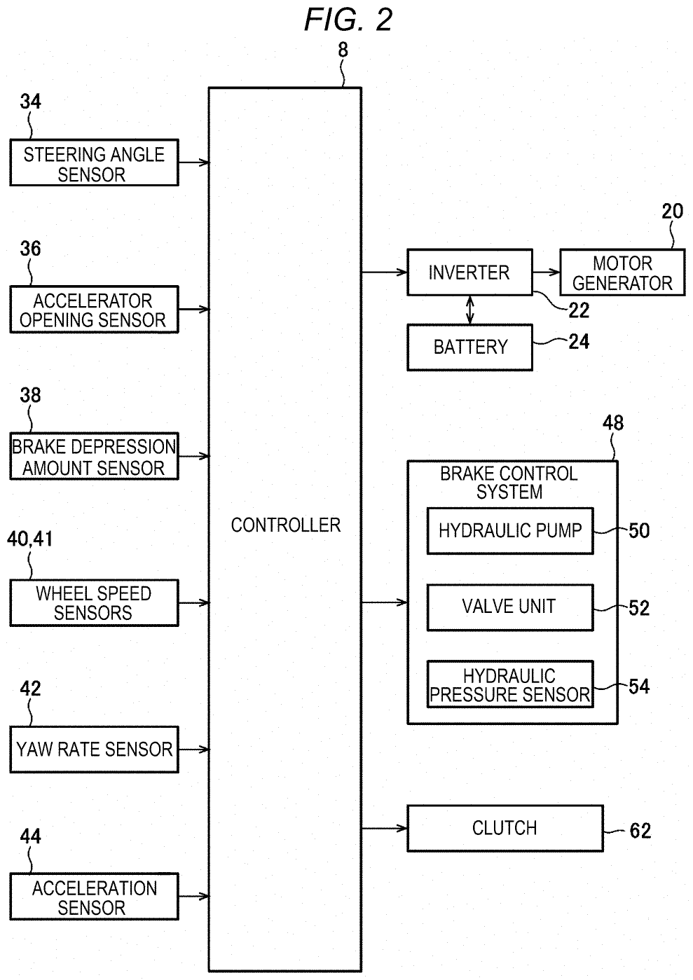

First, with reference to FIGS. 1 and 2, the vehicle to which the vehicle control system according to the embodiment of the present disclosure has been applied will be described. FIG. 1 is a block diagram schematically illustrating the overall structure of the vehicle according to the embodiment of the present disclosure and FIG. 2 is a block diagram illustrating the electric structure of the vehicle according to the embodiment of the present disclosure.

As illustrated in FIG. 1, a motor generator 20 (rotary electric machine) is installed in the front portion of the vehicle body of a vehicle 1 as a prime mover (drive source) for driving left and right front wheels 2. This vehicle 1 is configured as a so-called FF vehicle. The wheels 2 and 3 of the vehicle 1 are suspended by the vehicle body via a suspension 70 including elastic members (typically, springs), suspension arms, and the like.

The motor generator 20 has the function (that is, the function as the prime mover (electric motor)) of driving the front wheels 2 and the function (that is, the function as a generator) of regenerating electric power by being driven by the front wheels 2. The motor generator 20 transmits power to and receives power from the front wheels 2 via a transmission 6 and is controlled by a controller 8 via an inverter 22. Furthermore, the motor generator 20 is connected to a battery 24. When generating a driving force, the motor generator 20 receives electric power from the battery 24. When performing regeneration, the motor generator 20 charges the battery 24 by supplying electric power thereto.

In addition, in the vehicle 1, the rotary shaft of the motor generator 20 and the rotary shaft of the transmission 6 are connected to each other via a disengageable clutch 62. For example, switching between engagement and disengagement of the clutch 62 is controlled by the hydraulic pressure of the transmission 6.

The vehicle 1 has a steering device 26 that includes a steering wheel (steering) 28, a steering shaft 30, and the like, a steering angle sensor 34 that detects the steering angle of the steering device 26 based on the rotation angle of the steering wheel 28 and the position of a steering rack (not illustrated), an accelerator opening sensor 36 that detects the accelerator opening corresponding to the amount of depression of an accelerator pedal 35, a brake depression amount sensor 38 that detects the amount of depression of the brake pedal, wheel speed sensors 40 that detect the speeds (front wheel speeds) of the front wheels 2, wheel speed sensors 41 that detect the speeds (rear wheel speeds) of the rear wheels 3, a yaw rate sensor 42 that detects the yaw rate, and an acceleration sensor 44 that detects the acceleration. These sensors output detection values to the controller 8.

In addition, the steering angle sensor 34 may detect, as the steering angle, various state values (such as the rotation angle of a motor that applies an assist torque, and the displacement of a rack of a rack and pinion) in the steering system and the turning angle of the front wheels 2, instead of the rotation angle of the steering wheel 28.

In addition, the vehicle 1 has a brake control system 48 that supplies a brake fluid pressure to the wheel cylinders and brake calipers of the brake devices 46 provided in the wheels 2 and 3. The brake control system 48 has a hydraulic pump 50 that generates the brake fluid pressure required to generate braking forces in the brake devices 46 provided in the wheels 2 and 3. The hydraulic pump 50 is driven by, for example, the electric power supplied by the battery 24 and can produce the brake fluid pressure required to generate braking forces in the brake devices 46 even when the brake pedal is not depressed.

In addition, the brake control system 48 has valve units 52 (specifically, a solenoid valve), provided in the hydraulic pressure supply line extending to the brake device 46 of the wheels 2 and 3, that control the hydraulic pressures supplied from the hydraulic pump 50 to the brake devices 46 of the wheels 2 and 3. For example, the openings of the valve units 52 are changed by adjusting, for example, the amount of electric power supplied from the battery 24 to the valve units 52. In addition, the brake control system 48 has hydraulic pressure sensors 54 that detect the hydraulic pressures supplied from the hydraulic pump 50 to the brake devices 46 of the wheels 2 and 3. The hydraulic pressure sensors 54 are disposed, for example, in the connection portions between the valve units 52 and the hydraulic pressure supply lines on the downstream side thereof, detect the hydraulic pressures on the downstream side of the valve units 52, and output the detected values to the controller 8.

The brake control system 48 described above calculates the hydraulic pressures to be independently supplied to the wheel cylinders and brake calipers of the wheels 2 and 3 based on the braking force command value input from the controller 8 and the detection values of the hydraulic pressure sensors 54 and controls the number of revolutions of the hydraulic pump 50 and the openings of the valve units 52.

In addition, the brake control system 48 includes an anti-lock brake system (ABS) that controls the braking force of the brake device 46 to prevent the wheels 2 and 3 from being locked. Specifically, when the wheels 2 and 3 are locked (in other words, when the wheels 2 and 3 slip), the brake control system 48 controls the hydraulic pump 50 and valve units 52 so as to repeat the operation of forcibly lowering the brake fluid pressure and the operation of raising the brake fluid pressure again in a short time to unlock the wheels 2 and 3. Specifically, the brake control system 48 obtains a predetermined wheel state value indicating the locked state of the wheels 2 and 3, determines that the wheels 2 and 3 have been lock when this wheel state value exceeds a predetermined threshold, and operates the ABS. For example, the wheel state value is the difference (referred to below as the “front and rear wheel speed difference”) between the front wheel speed and the rear wheel speed or the slip rates of the wheels 2 and 3. It should be noted here that the front and rear wheel speed difference is defined as an absolute value.

As illustrated in FIG. 2, the controller 8 according to the embodiment outputs control signals for controlling the motor generator 20, the clutch 62, and the hydraulic pump 50 and valve units 52 of the brake control system 48 based on the detection signals of the above sensors 18, 34, 36, 38, 40, 41, 42, 44, and 54 and the detection signals output by various operational state sensors that detect the operational states of the vehicle 1.

The controller 8 is a well-known microcomputer-based control unit and includes a circuit. The controller 8 includes one or more microprocessors as CPUs (central processing units) that execute programs, a memory that includes, for example, a RAM (random access memory) and a ROM (read only memory) and stores programs and data, an input-output bus through which electric signals are input and output, and the like.

It should be noted here that the system including the motor generator 20, the steering wheel 28, the steering angle sensor 34, the break control system 48, and the controller 8 corresponds to the “vehicle control system” according to some embodiments of the present disclosure. In addition, the brake control system 48 and the controller 8 correspond to the “controller” according to some embodiments of the present disclosure. Strictly speaking, the control described below is achieved by both the brake control system 48 and the controller 8, but these units may be collectively referred to as the “controller 8” for the sake of simplicity. That is, the “controller 8” may include the brake control system 48.

### <Details on Control>

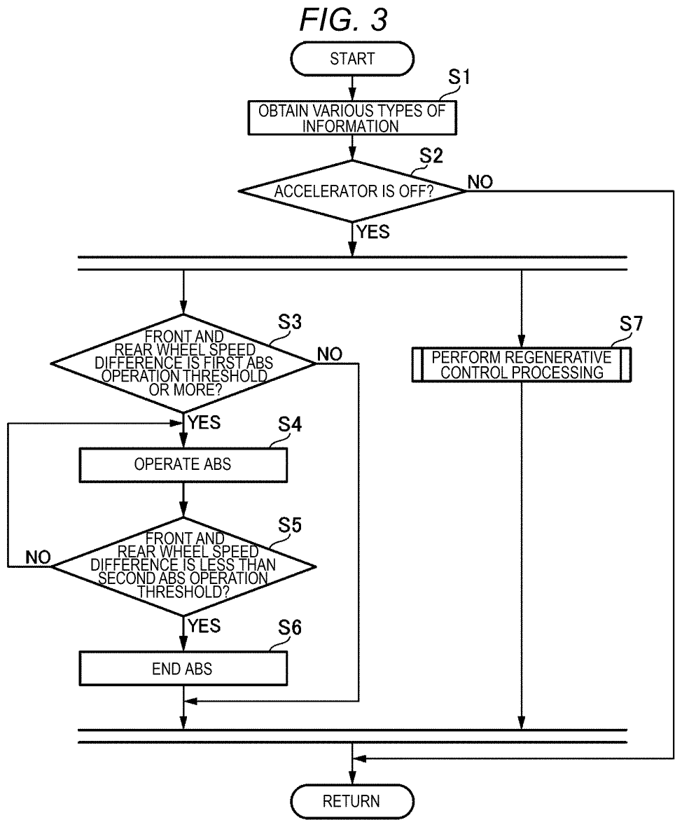

Next, the control performed by the controller 8 in the embodiment of the present disclosure will be described. First, an overall flow of the processing performed by the controller 8 in the embodiment of the present disclosure will be described with reference to FIG. 3. FIG. 3 is a flowchart illustrating the overall control processing by the embodiment of the present disclosure.

The overall control processing in FIG. 3 is started when the ignition of the vehicle 1 is turned on and the power to the controller 8 is turned on and is repeatedly executed in a predetermined cycle (for example, 50 ms). This overall control processing is processing concerning the application of a braking force to the vehicle 1 when the accelerator is off.

First, in step S1, the controller 8 obtains various types of sensor information about the operational state of the vehicle 1. Specifically, as illustrated in FIG. 2, the controller 8 obtains, as the information about the operational state, the detection signals output by the various sensors described above, including the steering angle of a steering 28 detected by the steering angle sensor 34, the accelerator opening detected by accelerator opening sensor 36, the brake pedal depression amount detected by the brake depression amount sensor 38, the front wheel speed and the rear wheel speed detected by wheel speed sensors 40 and 41, the yaw rate detected by the yaw rate sensor 42, the acceleration detected by the acceleration sensor 44, the hydraulic pressure detected by the hydraulic pressure sensor 54, the gear stage currently set in the transmission 6 of the vehicle 1, and the like.

Next, in step S2, the controller 8 determines whether the accelerator pedal 35 is in the off state (that is, the accelerator is off) based on the accelerator opening obtained in step S1. When it is determined that the accelerator is off (Yes in step S2), the controller 8 proceeds to step S3 and step S7. When it is not determined that the accelerator is off (No in step S2), that is, when the accelerator pedal 35 is in the on state (that is, the accelerator is on), the controller 8 ends the overall control processing.

Next, in step S3, the controller 8 obtains the front and rear wheel speed difference based on the front wheel speed and the rear wheel speed obtained in step S1 and determines whether this front and rear wheel speed difference is equal to or more than the first ABS operation threshold (corresponding to the “first threshold” in the present disclosure) concerning the operation of the ABS. As a result, when it is not determined that the front and rear wheel speed difference is equal to or more than the first ABS operation threshold (No in step S3), that is, when the front and rear wheel speed difference is less than the first ABS operation threshold, the controller 8 ends the overall control processing. In this case, the controller 8 does not operate the ABS.

In contrast, when it is determined that the front and rear wheel speed difference is equal to or more than the first ABS operation threshold (Yes in step S3), the controller 8 proceeds to step S4 and operates the ABS. Specifically, the controller 8 (strictly speaking, the brake control system 48) controls the hydraulic pump 50 and the valve unit 52 so as to repeat, in a short time, the operation of forcibly lowering the brake fluid pressure and the operation of raising the brake fluid pressure again to unlock the wheels 2 and 3. Then the controller 8 proceeds to step S5.

Next, in step S5, the controller 8 determines whether the front and rear wheel speed difference is less than the second ABS operation threshold (less than the first ABS operation threshold) concerning the termination of the ABS. That is, the controller 8 determines whether the front and rear wheel speed difference that exceeded the first ABS operation threshold has reduced to the second ABS operation threshold that is less than the first ABS operation threshold due to the operation of the ABS. As a result, it is determined that the front and rear wheel speed difference is less than the second ABS operation threshold (Yes in step S5), the controller 8 proceeds to step S6 and ends the ABS operation. Then, the controller 8 ends the overall control processing. In contrast, when it is not determined that the front and rear wheel speed difference is less than the second ABS operating threshold (No in step S5), that is, when the front and rear wheel speed difference is equal to or more than the second ABS operating threshold, the controller 8 returns to step S4. In this case, the controller 8 continues to operate the ABS until the front and rear wheel speed difference becomes less than the second ABS operation threshold.

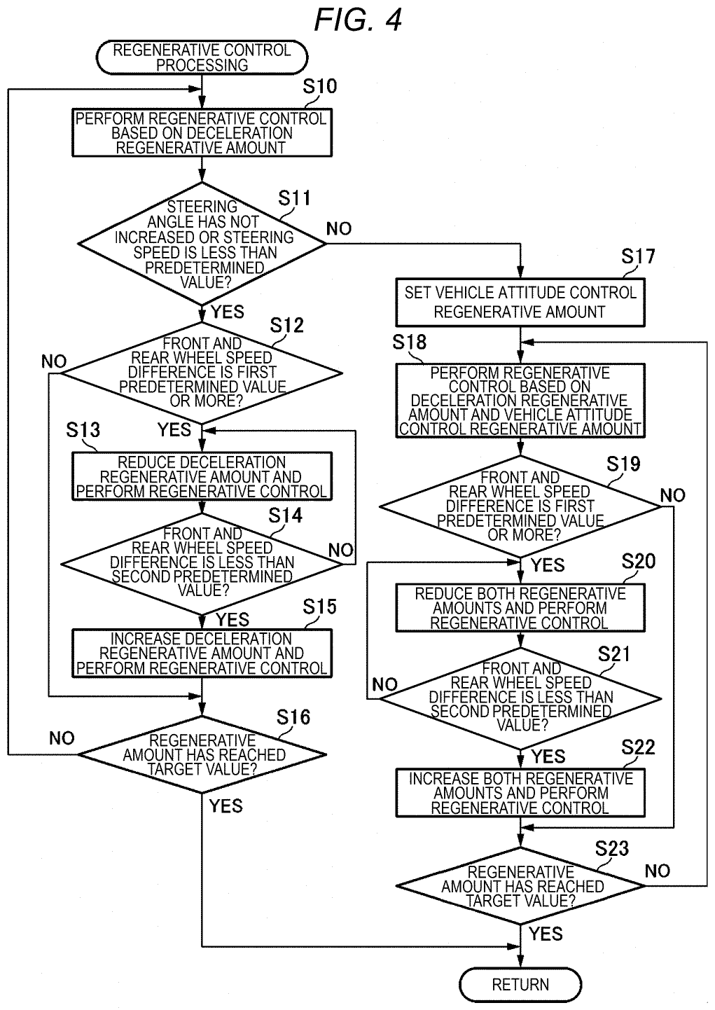

On the other hand, in parallel with the processing from steps S3 to S6 described above, in step S7, the controller 8 performs regenerative control processing (FIG. 4) for applying a braking force to the vehicle 1 (that is, for achieving regenerative braking) by performing regeneration via the motor generator 20. Specifically, in this regenerative control processing, the controller 8 performs regenerative braking via the motor generator 20 to decelerate the vehicle 1 and, when the steering is turned, to perform vehicle attitude control. In particular, in the embodiment, the controller 8 performs the regenerative braking via the generator 20 for deceleration and vehicle attitude control of the vehicle 1 in the range in which the ABS does not operate.

Next, the regenerative control processing according to the embodiment of the present disclosure will be described with reference to FIG. 4. FIG. 4 is a flowchart of the regenerative control processing according to the embodiment of the present disclosure. This regenerative control processing is performed in the overall control processing described above, specifically in step S7 of FIG. 3.

When the regenerative control processing is started, in step S10, the controller 8 sets the amount (corresponding to the braking force to be applied to the vehicle 1 by regeneration via the motor generator 20 to decelerate the vehicle 1 and is referred to below as the “deceleration regenerative amount”, which is defined as an absolute value) of regeneration via the motor generator 20 for decelerating the vehicle 1 based on the operational state of the vehicle 1 obtained in the step S1 above, and performs the control (corresponding to the first regenerative control in the present disclosure) for regeneration via the motor generator 20. In particular, the controller 8 sets the target value of the deceleration regenerative amount and performs the regenerative control via the motor generator 20 so as to increase the deceleration regenerative amount toward the target value at a predetermined change rate. For example, the controller 8 performs the regenerative control so as to apply the braking force equivalent to engine braking to the vehicle 1. Then, the controller 8 proceeds to step S11.

In step S11, the controller 8 determines whether the steering angle has not increased or whether the steering speed, which may be calculated from the steering angle, is less than a predetermined value based on the steering angle of the steering 28 obtained in step S1. Here, the controller 8 determines whether the steering 28 is not turned. As a result, when it is determined that the steering angle has not increased or that the steering speed is less than the predetermined value (Yes in step S11), that is, when the steering 28 is not turned, the controller 8 proceeds to step S12.

In the processing in step S12 and later, the controller 8 performs the regenerative control via the motor generator 20 to decelerate the vehicle 1 in the range in which the ABS does not operate. First, in step S12, the controller 8 obtains the front and rear wheel speed difference based on the front wheel speed and the rear wheel speed obtained in step S1 and determines whether this front and rear wheel speed difference is equal to or more than the first predetermined value (corresponding to the “second threshold” in the present disclosure) that is less than the first ABS operation threshold described above. It should be noted here that the first predetermined value may be set less than the second ABS operation threshold described above. As a result of step S12, when it is not determined that the front and rear wheel speed difference is equal to or more than the first predetermined value (No in step S12), that is, when the front and rear wheel speed difference is less than the first predetermined value, the controller 8 proceeds to step S16. In this case, since the ABS is unlikely to operate, the controller 8 does not perform the regenerative control to decelerate the vehicle 1 in the range in which the ABS does not operate.

In contrast, when it is determined that the front and rear wheel speed difference is equal to or more than the first predetermined value (Yes in step S12), the controller 8 proceeds to step S13, reduces the deceleration regenerative amount set in step S10 so as to reduce the front and rear wheel speed difference, and performs the regenerative control via the motor generator 20. This prevents the front and rear wheel speed difference from exceeding the first ABS operation threshold and prevents the ABS from operating. In particular, the controller 8 performs the regenerative control via the motor generator 20 so as to reduce the deceleration regenerative amount at a predetermined change rate. For example, the controller 8 reduces the deceleration regenerative amount at a change rate that does not make the driver feel uncomfortable. Then, the controller 8 proceeds to step S14.

Next, in step S14, the controller 8 determines whether the front and rear wheel speed difference is less than the second predetermined value (corresponding to the “third threshold” in the present disclosure) that is less than the first predetermined value. That is, by reducing the deceleration regenerative amount, the controller 8 determines whether the front and rear wheel speed difference that exceeded the first predetermined value has reduced to the second predetermined value that is less than the first predetermined value. As a result, when it is not determined that the front and rear wheel speed difference is less than the second predetermined value (No in step S14), that is, when the front and rear wheel speed difference is equal to or more than the second predetermined value, the controller 8 returns to step S13. In this case, the controller 8 continues to reduce the deceleration regenerative amount until the front and rear wheel speed difference reaches the second predetermined value.

In contrast, when it is determined that the front and rear wheel speed difference is less than the second predetermined value (Yes in step S14), the controller 8 proceeds to step S15. In step S15, the controller 8 stops reducing the deceleration regenerative amount, increases the deceleration regenerative amount again, and performs the regenerative control via the motor generator 20. Specifically, the controller 8 increases the deceleration regenerative amount at a change rate less than the change rate (the change rate applied in step S10) applied to increase the deceleration regenerative amount before the front and rear wheel speed difference becomes equal to or more than the first predetermined value. This ensures the execution of the regenerative braking for vehicle deceleration while surely preventing the ABS from operating. In addition, the controller 8 sets a target value less than the target value applied to increase the deceleration regenerative amount before the front and rear wheel speed difference became equal to or more than the first predetermined value and increases the deceleration regenerative amount toward the target value. Then, the controller 8 proceeds to step S16.

Next, in step S16, the controller 8 determines whether the deceleration regenerative amount by the motor generator 20 has reached the target value. As a result, when it is determined that the deceleration regenerative amount has reached the target value (Yes in step S16), the controller 8 ends the regenerative control processing. In contrast, when it is not determined that the deceleration regenerative amount has reached the target value (No in step S16), the controller 8 returns to step S10. In this case, the controller 8 repeats the processing in step S10 and later until the deceleration regenerative amount reaches the target value.

In contrast, in step S11, when it is not determined that the steering angle has not increased or the steering speed is less than the predetermined value (No in step S11), that is, when the steering angle has increased and the steering speed is equal to or more than the predetermined value, the controller 8 proceeds to step S17. Since the steering 28 is turned in this case, the controller 8 performs vehicle attitude control based on the steering angle detected by the steering angle sensor 34 to improve the turning performance, the operation stability, head-turning performance, and the like of the vehicle 1 according to an operation of the steering 28 by the driver in the subsequent processing.

In the processing in step S17 and later, the controller 8 performs the regenerative control via the motor generator 20 for vehicle deceleration and vehicle attitude control in the range in which the ABS does not operate. In this case, the controller 8 performs the regenerative control (corresponding to the “second regenerative control” in the present disclosure) for vehicle attitude control in addition to the regenerative control (corresponding to the “first regenerative control” in the present disclosure) for vehicle deceleration described above.

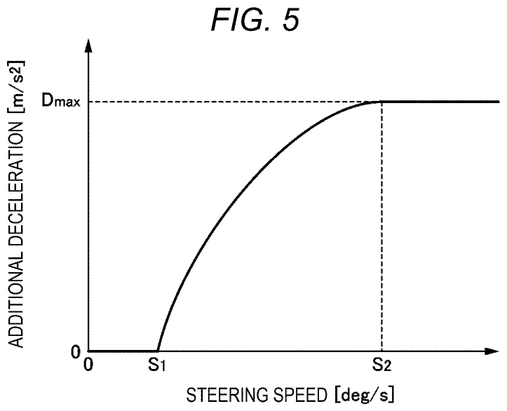

First, in step S17, the controller 8 sets the amount (which corresponds to the braking force to be applied to the vehicle 1 by regeneration via the motor generator 20 for controlling the attitude (behavior) of the vehicle 1 and is referred to below as the “vehicle attitude control regenerative amount” defined as an absolute value) of regeneration via the motor generator 20 for vehicle attitude control based on the steering speed. Specifically, the controller 8 first sets the additional deceleration corresponding to the current steering speed based on the relationship between the steering speed and the additional deceleration as illustrated in the map in FIG. 5 before setting the vehicle attitude control regenerative amount. This additional deceleration is the deceleration to be added to the vehicle 1 in response to a steering operation to control the vehicle attitude according to the intention of a turning operation of the steering 28 by the driver.

In FIG. 5, the horizontal axis represents the steering speed and the vertical axis represents the additional deceleration. As illustrated in FIG. 5, when the steering speed is equal to or less than a threshold S1, the corresponding additional deceleration is 0. That is, when the steering speed is equal to or less than the threshold S1, the controller 8 does not perform the control for adding the deceleration to the vehicle 1 based on a steering operation. In contrast, when the steering speed exceeds the threshold S1, as the steering speed increases, the additional deceleration corresponding to this steering speed asymptotically approaches a predetermined upper limit value Dmax. That is, as the steering speed increases, the additional deceleration increases and the increase rate of the increase amount reduces. This upper limit value Dmax is set to a deceleration (for example, 0.5 m/s²≈0.05 G) that does not make the driver feel intervention of control even if the deceleration is added to the vehicle 1 according to a steering operation. Furthermore, when the steering speed is equal to or more than a threshold S2 that is more than the threshold S1, the additional deceleration is maintained at the upper limit Dmax.

Then, the controller 8 sets the vehicle attitude control regenerative amount based on the additional deceleration set as described above. Specifically, the controller 8 determines the braking force (deceleration torque) to be applied to the vehicle 1 to achieve the additional deceleration based on the operational state of the vehicle 1 obtained in step S1 above, and sets the vehicle attitude control regenerative amount for achieving this braking force by the motor generator 20. It should be noted here that this vehicle attitude control regenerative amount is assumed to be less than the deceleration regenerative amount. After step S17, the controller 8 proceeds to step S18.

Next, in step S18, the controller 8 performs the regenerative control via the motor generator 20 based on the deceleration regenerative amount set in step S10 and the vehicle attitude control regenerative amount set in step S17. Specifically, the controller 8 performs the regenerative control via the motor generator 20 so as to increase the vehicle attitude control regenerative amount at a predetermined change rate and, if the deceleration regenerative amount does not reach the target value, increase the deceleration regenerative amount at a predetermined change rate (if the deceleration regenerative amount reaches the target value, the deceleration regenerative amount only needs to be kept at the target value). Then, the controller 8 proceeds to step S19.

Next, in step S19, the controller 8 obtains the front and rear wheel speed difference based on the front wheel speed and the rear wheel speed obtained in step S1 and determines whether this front and rear wheel speed difference is equal to or more than the first predetermined value (corresponding to the “second threshold” in the present disclosure) described above. As a result, when it is not determined that the front and rear wheel speed difference is equal to or more than the first predetermined value (No in step S19), that is, when the front and rear wheel speed difference is less than the first predetermined value, the controller 8 proceeds to step S23. In this case, since the ABS is unlikely to operate, the controller 8 does not perform the regenerative control for performing vehicle deceleration and vehicle attitude control in the range in which the ABS does not operate.

In contrast, when it is determined that the front and rear wheel speed difference is equal to or more than the first predetermined value (Yes in step S19), the controller 8 proceeds to step S20, reduces the deceleration regenerative amount set in step S10 so as to reduce the front and rear wheel speed difference, and performs the regenerative control via the motor generator 20 by reducing the vehicle attitude control regenerative amount set in step S17. This prevents the front and rear wheel speed difference from exceeding the first ABS operation threshold and prevents the ABS from operating. Specifically, the controller 8 reduces the deceleration regenerative amount at a predetermined change rate and reduces the vehicle attitude control regenerative amount at a change rate corresponding to the change rate of the deceleration regenerative amount. Specifically, the controller 8 reduces the vehicle attitude control regenerative amount at a change rate less than the change rate of the deceleration regenerative amount. In one example, the controller 8 reduces the vehicle attitude control regenerative amount at the change rate obtained by multiplying the change rate of the deceleration regenerative amount by a predetermined value less than 1. Alternatively, for example, the controller 8 reduces the deceleration regenerative amount and the vehicle attitude control regenerative amount at a change rate that does not make the driver feel uncomfortable. Then, the controller 8 proceeds to step S21.

Next, in step S21, the controller 8 determines whether the front and rear wheel speed difference is less than the above second predetermined value (corresponding to the “third threshold” in the present disclosure). That is, the controller 8 determines whether the front and rear wheel speed difference that exceeded the first predetermined value has reduced to the second predetermined value, which is less than the first predetermined value by reducing the deceleration regenerative amount and the vehicle attitude control regenerative amount. As a result, when it is not determined that the front and rear wheel speed difference is less than the second predetermined value (No in step S21), that is, when the front and rear wheel speed difference is equal to or more than the second predetermined value, the controller 8 returns to step S20. In this case, the controller 8 continues to reduce the deceleration regenerative amount and the vehicle attitude control regenerative amount until the front and rear wheel speed difference becomes less than the second predetermined value.

In contrast, when it is determined that the front and rear wheel speed difference is less than the second predetermined value (Yes in step S21), the controller 8 proceeds to step S22. In step S22, the controller 8 stops reducing the deceleration regenerative amount and the vehicle attitude control regenerative amount, increases the deceleration regenerative amount and the vehicle attitude control regenerative amount again, and performs the regenerative control via the motor generator 20. Specifically, the controller 8 increases the deceleration regenerative amount at a change rate less than the change rate (the change rate applied in step S10 or S18) applied to increase the deceleration regenerative amount before the front and rear wheel speed difference becomes equal to or more than the first predetermined value, and increases the vehicle attitude control regenerative amount at a change rate less than the change rate (the change rate applied in step S18) applied to increase the deceleration regenerative amount before the front and rear wheel speed difference becomes equal to or more than the first predetermined value. This ensures the execution of the regenerative braking for vehicle deceleration and vehicle attitude control while surely preventing the ABS from operating. In addition, the controller 8 sets a target value less than the target value applied to increase the deceleration regenerative amount before the front and rear wheel speed difference becomes equal to or more than the first predetermined value to increase the deceleration regenerative amount toward the target value, and sets a target value less than the target value applied to increase the vehicle attitude control regenerative amount before the front and rear wheel speed difference becomes equal to or more than the first predetermined value to increase the vehicle attitude control regenerative amount toward the target value. Then, the controller 8 proceeds to step S23.

Next, in step S23, the controller 8 determines whether the deceleration regenerative amount and the vehicle attitude control regenerative amount by the motor generator 20 have reached the target values. As a result, when it is determined that the deceleration regenerative amount and the vehicle attitude control regenerative amount have reached the target values (Yes in step S23), the controller 8 ends the regenerative control processing. In contrast, when it is not determined that the deceleration regenerative amount and the vehicle attitude control regenerative amount have reached the target values (No in step S23), the controller 8 returns to step S18. In this case, the controller 8 repeats the processing in step S18 and later until the deceleration regenerative amount and the vehicle attitude control regenerative amount reach the target values.

### Operation and Effect

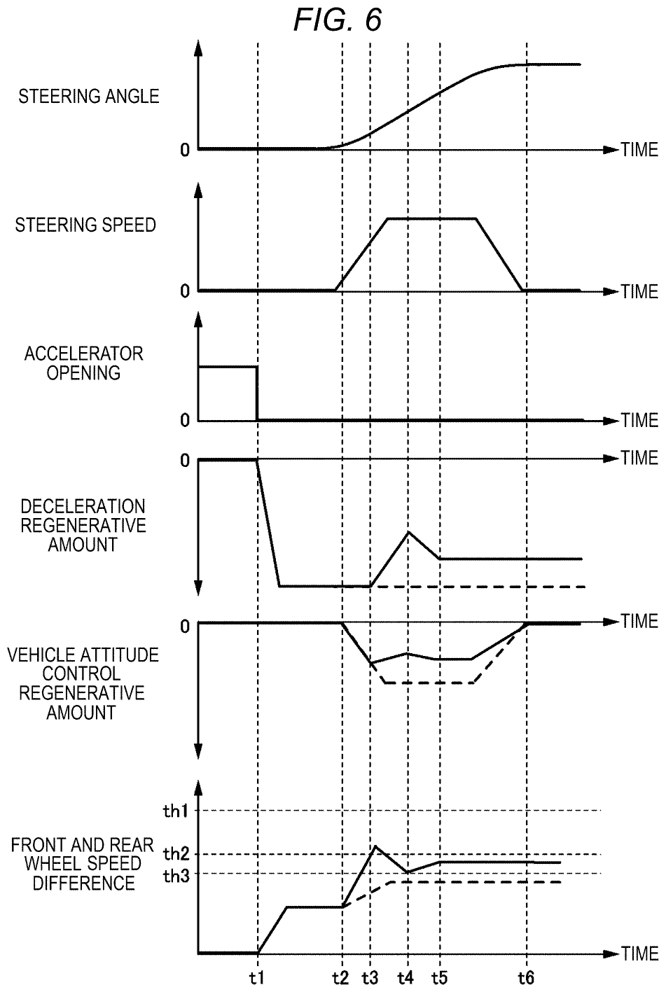

Next, the operation and effect of the vehicle control system according to the embodiment of the present disclosure will be described with reference to the time chart in FIG. 6. FIG. 6 is time charts when the control according to the embodiment described above is performed. FIG. 6 represents time on the horizontal axis and represents, in order from the top, the steering angle, the steering speed, the accelerator opening, the deceleration regenerative amount, the vehicle attitude control regenerative amount, and the front and rear wheel speed difference on the vertical axes. In addition, the solid lines in FIG. 6 represent changes in parameters when the front and rear wheel speed difference becomes equal to or more than a first predetermined value Th2 during the regenerative braking via the motor generator 20 for vehicle deceleration and vehicle attitude control, and the control performed in this case will be mainly described below. On the other hand, the dashed lines in FIG. 6 are present for comparison with the solid lines and represent changes in parameters when the front and rear wheel speed difference does not become equal to or more than the first predetermined value Th2 during the regenerative braking for vehicle deceleration and vehicle attitude control.

First, when the accelerator opening becomes 0 at time t1, that is, when the accelerator is off, the controller 8 increases the deceleration regenerative amount by the motor generator 20 and performs regenerative braking for decelerating the vehicle 1. When the deceleration regenerative amount reaches the target value, the controller 8 ends increase in the deceleration regenerative amount and keeps the deceleration regenerative amount at the target value. As described above, when the steering angle increases and the steering speed becomes equal to or more than a predetermined value (that is, when the steering 28 is turned) at time t2 during regenerative braking for vehicle deceleration, the controller 8 increases the vehicle attitude control regenerative amount by the motor generator 20 and further performs regenerative braking for vehicle attitude control.

After that, when the front and rear wheel speed difference becomes equal to or more than the first predetermined value Th2 that is set less than the first ABS operation threshold Th1 at time t3, the controller 8 reduces the deceleration regenerative amount and the vehicle attitude control regenerative amount. Specifically, the controller 8 reduces the deceleration regenerative amount at a predetermined change rate and reduces the vehicle attitude control regenerative amount at a change rate that is less than the change rate of the deceleration regenerative amount and corresponds to the change rate. As a result, the front and rear wheel speed difference reduces to a second predetermined value Th3 that is set less than the first predetermined value Th2 at time t4. It should be noted here that the controller 8 does not reduce the deceleration regenerative amount and the vehicle attitude control regenerative amount unless the front and rear wheel speed difference becomes equal to or more than the first predetermined value Th2 (see the broken lines). Specifically, the controller 8 maintains the deceleration regenerative amount at the initial target value and changes the vehicle attitude control regenerative amount based on the additional deceleration that corresponds to the steering speed.

Then, the controller 8 increases the deceleration regenerative amount and the vehicle attitude control regenerative amount again at time t4 when the front and rear wheel speed difference reaches the second predetermined value Th3. Specifically, the controller 8 increases the deceleration regenerative amount at a change rate that is less than the change rate applied to increase the deceleration regenerative amount before the front and rear wheel speed difference becomes equal to or more than the first predetermined value Th2, and increase the vehicle attitude control regenerative amount at a change rate that is less than the change rate applied to increase the vehicle attitude control regenerative amount before the front and rear wheel speed difference became equal to or more than the first predetermined value Th2. In addition, the controller 8 sets a target value less than the target value applied to increase the deceleration regenerative amount before the front and rear wheel speed difference becomes equal to or more than the first predetermined value Th2 and increases the deceleration regenerative amount toward the target value, and sets a target value less than the target value applied to increase the vehicle attitude control regenerative amount before the front and rear wheel speed difference becomes equal to or more than the first predetermined value Th2 and increases the vehicle attitude control regenerative amount toward the target value.

As a result, when the deceleration regenerative amount and the vehicle attitude control regenerative amount reach the target values at time t5, the controller 8 maintains these regenerative amounts at the target values. After that, when the steering angle becomes almost constant and the steering speed becomes less than the predetermined value at time t6, the controller 8 sets the vehicle attitude control regenerative amount to 0 and ends the regenerative braking for vehicle attitude control.

According to the embodiment described above, the controller 8 reduces the deceleration regenerative amount and the vehicle attitude control regenerative amount by the motor generator 20 if the front and rear wheel speed difference becomes equal to or more than the first predetermined value Th2 that is less than first ABS operation threshold Th1 when the accelerator is off and the steering 28 is turned. This surely prevents the front and rear wheel speed difference from exceeding the first ABS operation threshold Th1 when the regenerative braking via the motor generator 20 for deceleration and vehicle attitude control of the vehicle 1 is performed. Therefore, according to the embodiment, the deceleration and the vehicle attitude control of the vehicle 1 can be appropriately achieved by the regenerative braking via the motor generator 20 in the range in which the ABS does not operate.

In addition, according to the embodiment, the controller 8 sets the vehicle attitude control regenerative amount less than the deceleration regenerative amount, reduces the deceleration regenerative amount at a predetermined change rate when the front and rear wheel speed difference becomes equal to or more than the first predetermined value Th2, and reduces the vehicle attitude control regenerative amount at a change rate corresponding to the change rate of the deceleration regenerative amount. This can appropriately reduce the deceleration regenerative amount and the vehicle attitude control regenerative amount so as to appropriately ensure both the vehicle deceleration and the vehicle attitude control by the regenerative braking.

In addition, according to the embodiment, the controller 8 reduces the deceleration regenerative amount and the vehicle attitude control regenerative amount until the front and rear wheel speed difference reduces to the second predetermined value Th3 that is less than the first predetermined value Th2. That is, the controller 8 continues to reduce the regenerative amount until the front and rear wheel speed difference reduces to the second predetermined value Th3 or less that is less than the first predetermined value Th2 after the front and rear wheel speed difference becomes the first predetermined value Th2 or more. This can appropriately prevent the hunting concerning the front and rear wheel speed difference.

In addition, according to the embodiment, after the front and rear wheel speed difference reduces to the second predetermined value Th3, the controller 8 increases the deceleration regenerative amount at a change rate less than the change rate applied to increase the deceleration regenerative amount before the front and rear wheel speed difference becomes equal to or more than the first predetermined value Th2, and increases the vehicle attitude control regenerative amount at a change rate less than the change rate applied to increase the vehicle attitude control regenerative amount before the front and rear wheel speed difference becomes equal to or more than the first predetermined value Th2. This can ensure the execution of regenerative braking for vehicle deceleration and vehicle attitude control while surely preventing the ABS from operating.

### <Modification>

In the embodiment described above, if the front and rear wheel speed difference becomes equal to or more than the first predetermined value Th2 when the accelerator is off and the steering 28 is turned, the controller 8 reduces both the deceleration regenerative amount and the vehicle attitude control regenerative amount of the motor generator 20. However, in another example, the controller 8 may reduce only one of the deceleration regenerative amount and the vehicle attitude control regenerative amount. This can also prevent the ABS from operating when the regenerative braking via the motor generator 20 for deceleration and vehicle attitude control of the vehicle 1 is performed as compared with the case in which the deceleration regenerative amount and the vehicle attitude control regenerative amount are not reduced.

In the embodiment described above, the controller 8 performs control using the front and rear wheel speed difference as the “wheel state value” according to the present disclosure. However, in another example, the controller 8 may perform the above control according to the embodiment using the slip rates of the wheels 2 and 3 instead of the front and rear wheel speed difference. That is, the parameters used to determine the operation of the ABS only need to be applied as the “wheel state values”.

### DESCRIPTION OF REFERENCE SIGNS AND NUMERALS

1: vehicle
2: front wheel
3: rear wheel
8: controller
20: motor generator
22: inverter
26: steering device
28: steering wheel
34: steering angle sensor
36: accelerator opening sensor
40, 41: wheel speed sensor
46: brake device
48: brake control system

1. A vehicle control system, comprising:
a generator configured to perform power regeneration by being driven by a wheel of a vehicle;
a steering wheel configured to be operated by a driver;
a steering angle sensor configured to detect a steering angle corresponding to an operation of the steering wheel; and
a controller configured to perform first regenerative control that causes the generator to perform power regeneration so as to apply a braking force to the vehicle when an accelerator pedal of the vehicle is in an off state and perform second regenerative control that causes the generator to perform power regeneration so as to apply another braking force to the vehicle in order to control a vehicle attitude by generating, in the vehicle, a deceleration that corresponds to the steering angle detected by the steering angle sensor in addition to the first regenerative control when the accelerator pedal of the vehicle is in the off state and the steering wheel is turned,
wherein the controller is configured to operate an anti-lock brake system so as to suppress a locked state of the wheel when a predetermined wheel state value indicating the locked state of the wheel is equal to or more than a first threshold, and
the controller is configured to reduce a first regenerative amount of power applied in the first regenerative control and/or a second regenerative amount of power applied in the second regenerative control under a condition the wheel state value is equal to or more than a second threshold that is less than the first threshold when the accelerator pedal is in the off state and the steering wheel is turned.

2. The vehicle control system according to claim 1,
wherein the controller is configured to reduce both the first regenerative amount of power and the second regenerative amount of power under a condition that the wheel state value is equal to or more than the second threshold when the accelerator pedal is in the off state and the steering wheel is turned.

3. The vehicle control system according to claim 2,
wherein the controller is configured to set the second regenerative amount of power to be less than the first regenerative amount of power, and
reduce the first regenerative amount of power at a predetermined change rate and reduce the second regenerative amount of power at a change rate corresponding to the first regenerative amount of power.

4. The vehicle control system according to claim 3,
wherein the controller is configured to reduce the first regenerative amount of power and the second regenerative amount of power until the wheel state value reduces to a third threshold that is less than the second threshold.

5. The vehicle control system according to claim 4,
wherein the controller is configured to increase the first regenerative amount of power at a predetermined change rate before the wheel state value is equal to or more than the second threshold and, after the wheel state value reduces to the third threshold as a result of reducing the first regenerative amount of power because the wheel state value is equal to or more than the second threshold, increases the first regenerative amount of power again at a change rate less than the change rate used to increase the first regenerative amount of power before the wheel state value is equal to or more than the second threshold, and
the controller is further configured to increase the second regenerative amount of power at a predetermined change rate before the wheel state value is equal to or more than the second threshold and, after the wheel state value reduces to the third threshold as a result of reducing the second regenerative amount of power because the wheel state value is equal to or more than the second threshold, increases the second regenerative amount of power again at a change rate less than the change rate used to increase the second regenerative amount of power before the wheel state value is equal to or more than the second threshold.

6. The vehicle control system according to claim 5,
wherein the wheel state value is a difference between a wheel speed of a front wheel of the vehicle and a wheel speed of a rear wheel of the vehicle.

7. The vehicle control system according to claim 1, wherein the wheel state value is a difference between a wheel speed of a front wheel of the vehicle and a wheel speed of a rear wheel of the vehicle.

8. The vehicle control system according to claim 2,
wherein the controller is configured to reduce the first regenerative amount of power and the second regenerative amount of power until the wheel state value reduces to a third threshold that is less than the second threshold.

9. The vehicle control system according to claim 2,
wherein the wheel state value is a difference between a wheel speed of a front wheel of the vehicle and a wheel speed of a rear wheel of the vehicle.

10. The vehicle control system according to claim 3,
wherein the wheel state value is a difference between a wheel speed of a front wheel of the vehicle and a wheel speed of a rear wheel of the vehicle.

11. The vehicle control system according to claim 4,
wherein the wheel state value is a difference between a wheel speed of a front wheel of the vehicle and a wheel speed of a rear wheel of the vehicle.

12. The vehicle control system according to claim 8,
wherein the controller is configured to increase the first regenerative amount of power at a predetermined change rate before the wheel state value is equal to or more than the second threshold and, after the wheel state value reduces to the third threshold as a result of reducing the first regenerative amount of power because the wheel state value is equal to or more than the second threshold, increases the first regenerative amount of power again at a change rate less than the change rate used to increase the first regenerative amount of power before the wheel state value is equal to or more than the second threshold, and
the controller is further configured to increase the second regenerative amount of power at a predetermined change rate before the wheel state value is equal to or more than the second threshold and, after the wheel state value reduces to the third threshold as a result of reducing the second regenerative amount of power because the wheel state value is equal to or more than the second threshold, increases the second regenerative amount of power again at a change rate less than the change rate used to increase the second regenerative amount of power before the wheel state value is equal to or more than the second threshold.

13. The vehicle control system according to claim 12,
wherein the wheel state value is a difference between a wheel speed of a front wheel of the vehicle and a wheel speed of a rear wheel of the vehicle.
